(19) United States
(12) Patent Application Publication
(10) Pub. No.: US 2010/0297886 A1
(43) Pub. Date: Nov. 25, 2010

(54) Card connector capable of detecting card entry

(75) Inventor: Yaw-Huey Lai, Taipei County (TW)

Correspondence Address: BACON & THOMAS, PLLC, 625 SLATERS LANE, FOURTH FLOOR, ALEXANDRIA, VA, 22314-1176, US

(73) Assignee: TAI-SOL ELECTRONICS CO., LTD., Taipei City (TW)

(21) Appl. No.: 12/458,712

(22) Filed: Jul. 21, 2009

(30) Foreign Application Priority Data
May 19, 2009 (TW) 98208709

(51) Int. Cl. H01R 24/00

(52) U.S. Cl. 439/630

(57) ABSTRACT

A card connector is composed of a base, a cover, and a terminal set. The cover is made of a metal and covered onto the base in such a way that an entrance is formed at front sides of the base and the cover and a card space is formed between the base and the cover. The terminal set includes a plurality of terminals mounted to the base. One of the base and the cover includes a working spring strip located at one side of the card connector and the other includes a passive spring strip located at the same side of the card connector as the working spring strip. The working spring strip has a working portion interfering with the card space. When a card enters the card space, the card works on the working portion to force the working spring strip to contact the passive spring strip for perfect electric conduction.

### BACKGROUND OF THE INVENTION

1. Field of the Invention

The present invention relates generally to card connectors, and more particularly, to a card connector capable of detecting card entry.

2. Description of the Related Art

A conventional card connector usually includes two spring strips located at a lateral side thereof and spaced from each other for detecting entry of an electronic card. When the electronic card enters, one of the spring strips is forced by the card to deform itself for further contact with the other spring strip in such a way that a short circuit happens and then the entry of the card is detected. For example, Taiwanese Patent No. M267,600 disclosed a card connector having multiple spring strips for detecting whether or not a variety of electronic cards are fully inserted and write-protected. Such detection works when the card works on a contact terminal to force it to deform and to further contact a common terminal for electric conduction.

However, the aforesaid spring strips (the common and contact terminals) are a little complicated in design and the conventional card connector's insulated base must include corresponding slots for mounting the common and contact terminals. Under the circumstances, the production of the conventional card connector is uneasier and the assembly of the same is more complicated and difficult.

### SUMMARY OF THE INVENTION

The primary objective of the present invention is to provide a card connector capable of detecting card entry, which is structurally simple and can be conveniently assembled.

The foregoing objective of the present invention is attained by the card connector composed of a base, a cover, and a terminal set. The cover is made of a metal and covered onto the base in such a way that an entrance is formed at front sides of the base and the cover and a card space is formed between the base and the cover. The terminal set includes a plurality of terminals mounted to the base. One of the base and the cover includes at least one working spring strip located at one side thereof and the other includes at least one passive spring strip located at one side thereof and close to the working spring strips. The working spring strip has a working portion interfering with the card space. When a card enters the card space, the card works on the working portion to force the working spring strip to contact the passive spring strip for perfect electric conduction and thus for secure detection.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a bottom view of the first preferred embodiment of the present invention.

FIG. 4 is a sectional view taken along a line 4-4 indicated in FIG. 3.

FIG. 5 is a top view of a second preferred embodiment of the present invention, illustrating that the cover is removed and a card enters the card space to contact the working portion.

FIG. 6 is another bottom view of the first preferred embodiment of the present invention, illustrating that the card is inserted to a rear part of the card space.

FIG. 7 is a sectional view taken along a line 7-7 indicated in FIG. 6.

FIG. 8 is an enlarged view of a part A indicated in FIG. 7, illustrating the correlation between the contact portion and the guiding surface after the card is fully inserted to a rearmost end of the card space.

FIG. 9 is similar to FIG. 5, illustrating that the card is inserted to the rear part of the card connector.

FIG. 10 is an exploded view of a second preferred embodiment of the present invention.

FIG. 11 is a top view of the second preferred embodiment of the present invention, illustrating that the cover is removed and a card enters the card space to contact the working portion.

FIG. 12 is a sectional view taken along a line 12-12 indicated in FIG. 11.

FIG. 13 is similar to FIG. 11, illustrating that the card is inserted to a rear part of the card space.

FIG. 14 is a sectional view taken along a line 14-14 indicated in FIG. 13.

### DETAILED DESCRIPTION OF PREFERRED EMBODIMENTS

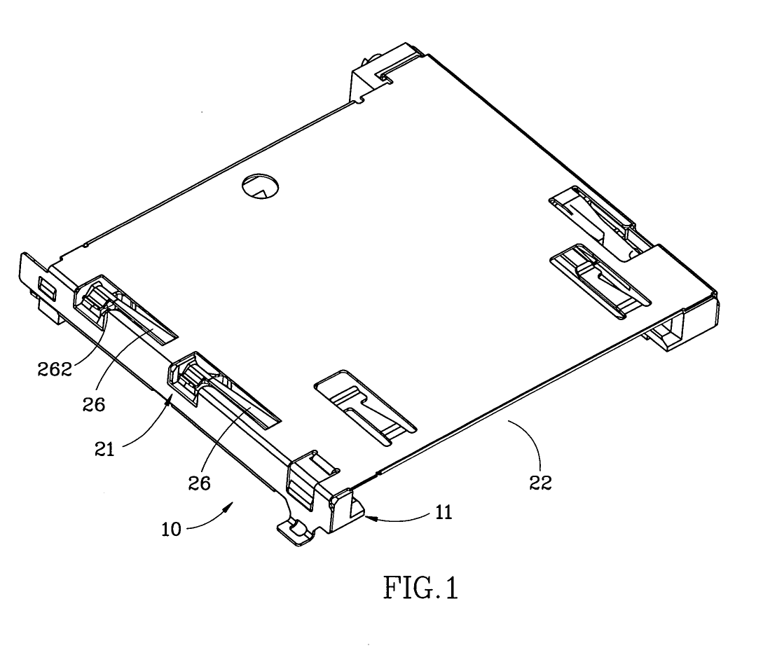

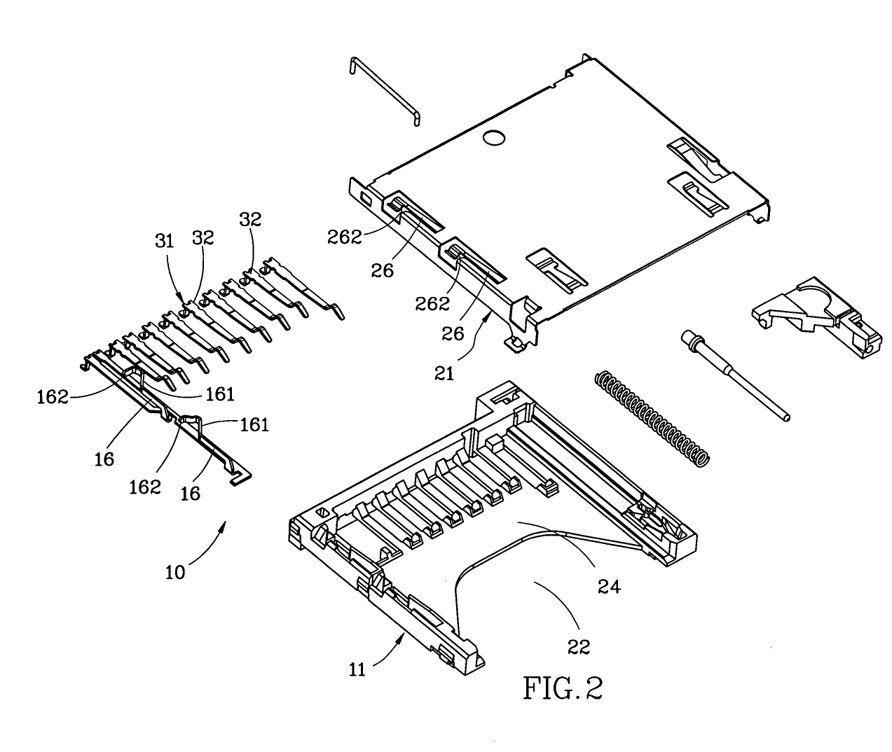

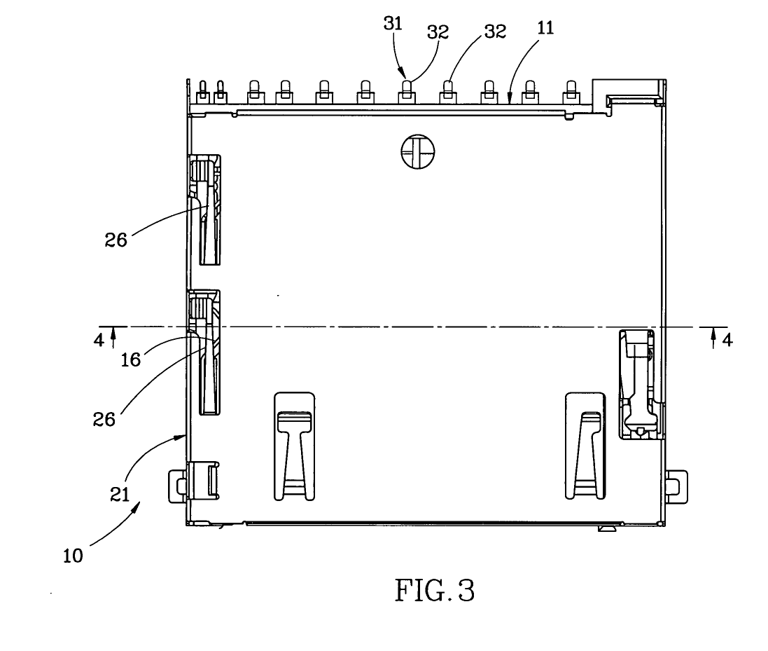

Referring to FIGS. 1-4, a card connector 10 capable of detecting card entry in accordance with a first preferred embodiment of the present invention is composed of a base 11, a cover 21, a terminal set 31.

The base 11 includes two working spring strips 16 mounted to one (right) side of the card connector 10 by insert molding.

The cover 21 is made of a metal and covered onto the base 11 in such a way that an entrance 22 is formed at front sides of the base 11 and the cover 21 and a card space 24 is formed between the base 11 and the cover 21. The cover 21 includes two passive spring strips 26 located at the same side of the card connector 10 as the working spring strips 16. The passive spring strips 26 are closer to an external side of the card connector 10 than the working spring strips 16. Each of the working spring strips 16 has a working portion 161 interfering with the card space 24 for working on and forcing the working spring strip 16 to warp toward the passive spring strip 26 for contact and electrical conduction with each other in such a way that the detection is accomplished. In this embodiment, each of the working portions 161 is a bevel facing the card space 24 and extending rearward; each of the working spring strips 16 further has a contact potion 162 extending toward the passive spring strip 26; each of the passive spring strips 26 further has an inclined guiding surface 262 corresponding to the contact portion 162 and facing a distal end of the contact portion 162. When an electronic card 99 is inserted into the card connector 10 to work on one of the working portions 161, the working spring strips 16 are forced to bend toward the corresponding passive spring strip 26 and meanwhile, each of the contact portions 162 contacts the corresponding guiding surface 262 to further force each of the passive spring strips 26 to deform. In the meantime, the rebounding resilience of the passive spring strip 26 keeps itself contacting the passive spring strip 26. In this embodiment, while deformed, each of the passive spring strips 26 bend upward.

The terminal set 31 includes a plurality of terminals 32 and are mounted to the base 11.

In this embodiment, one of the working spring strips 16 coordinates with one of the passive spring strips 26 for detection of entry of the card 99; the other working spring strip 16 coordinates with the other passive spring strip 26 for detection of write protection of the card 99.

For the convenience of recitation, the following operation of the first embodiment of the present invention only covers one of the working spring strips 16 and one of the passive spring strips 26 because the operation of the other working and passive spring strips 16 and 26 is almost similar to be skipped.

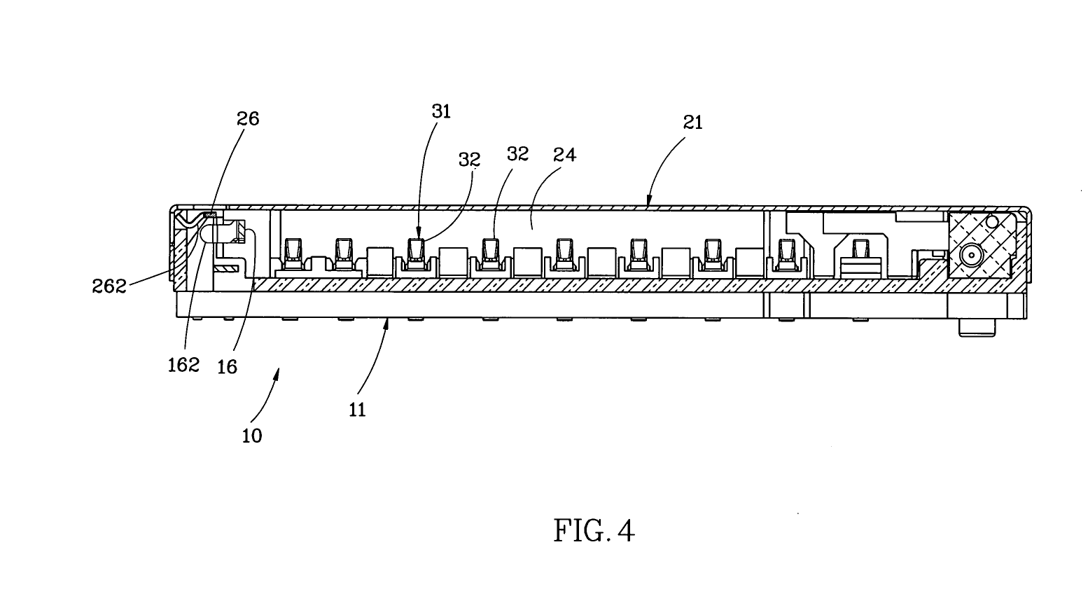

Referring to FIG. 4, when the card 99 is not inserted into the card connector 10, each of the contact portions 162 of the working spring strips 16 is spaced from the corresponding guiding surface 262 of the passive spring strip 26 in a predetermined interval without any contact with each other.

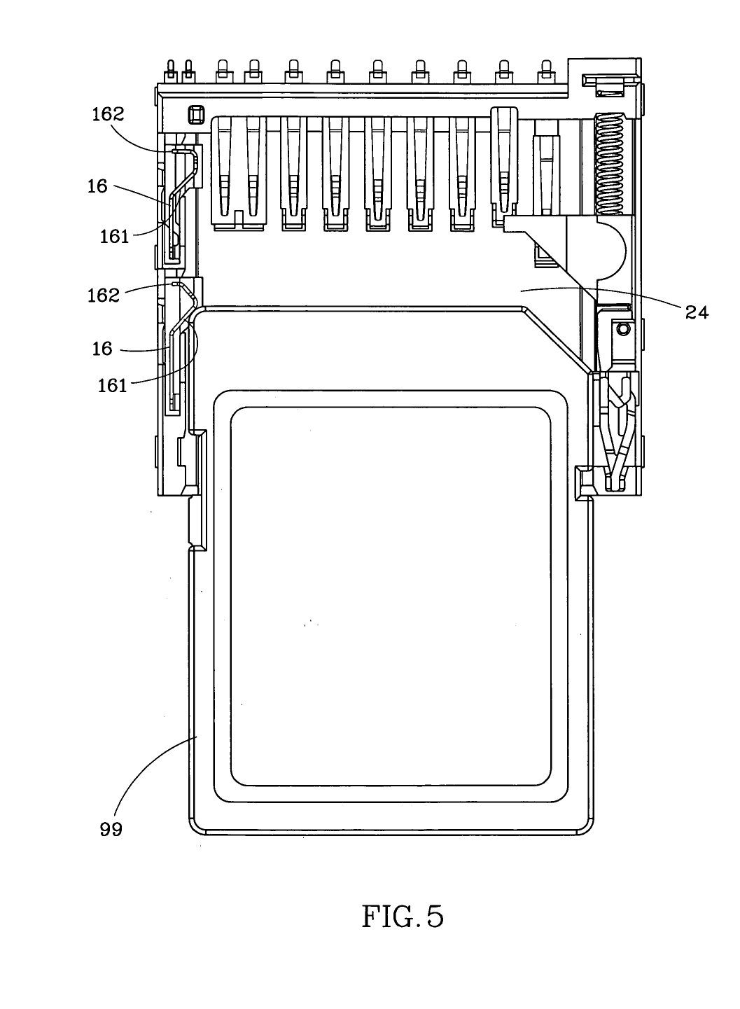

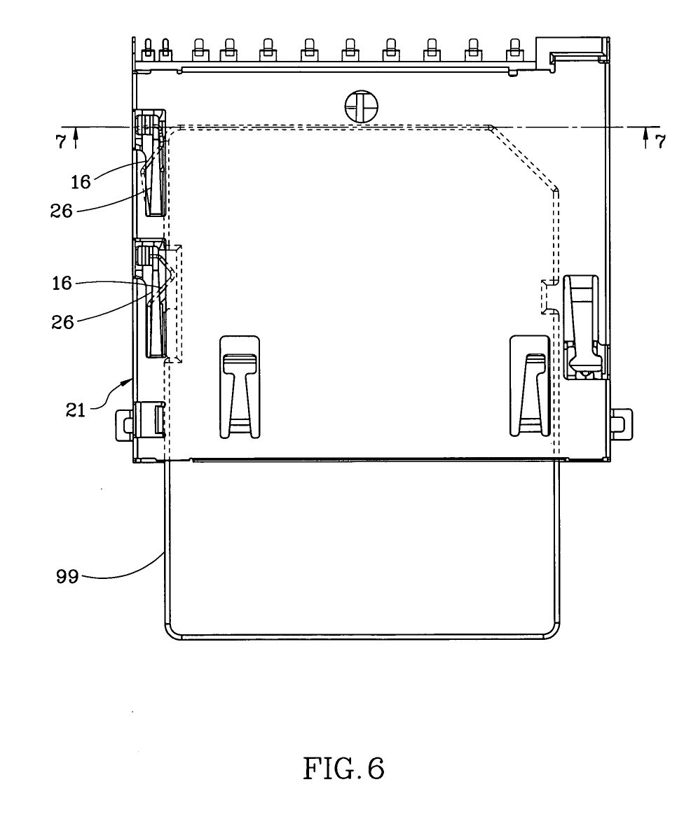

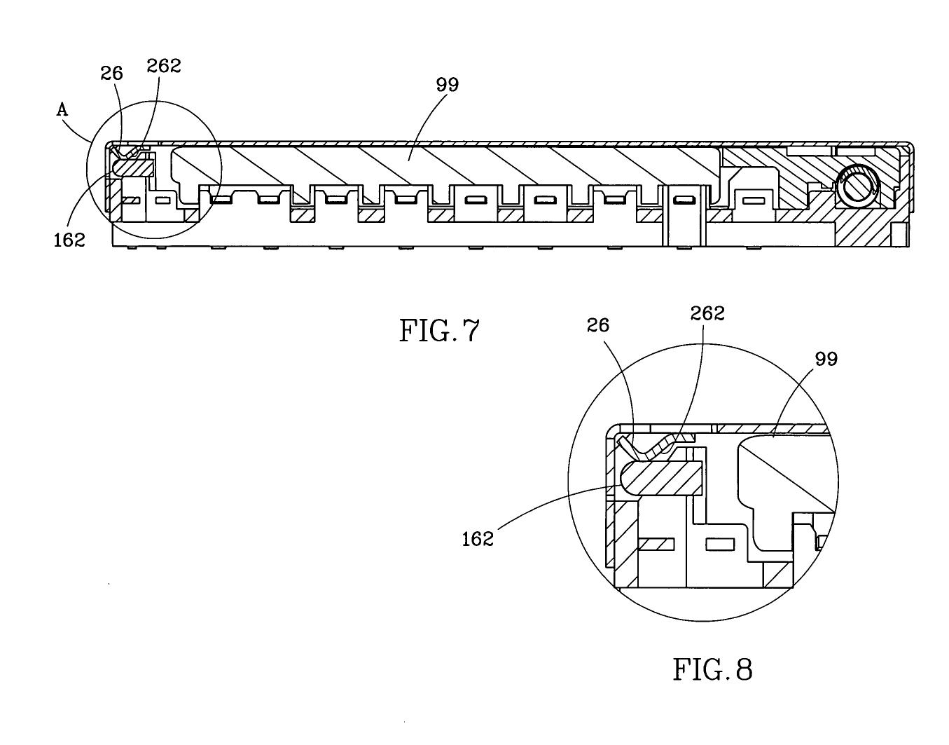

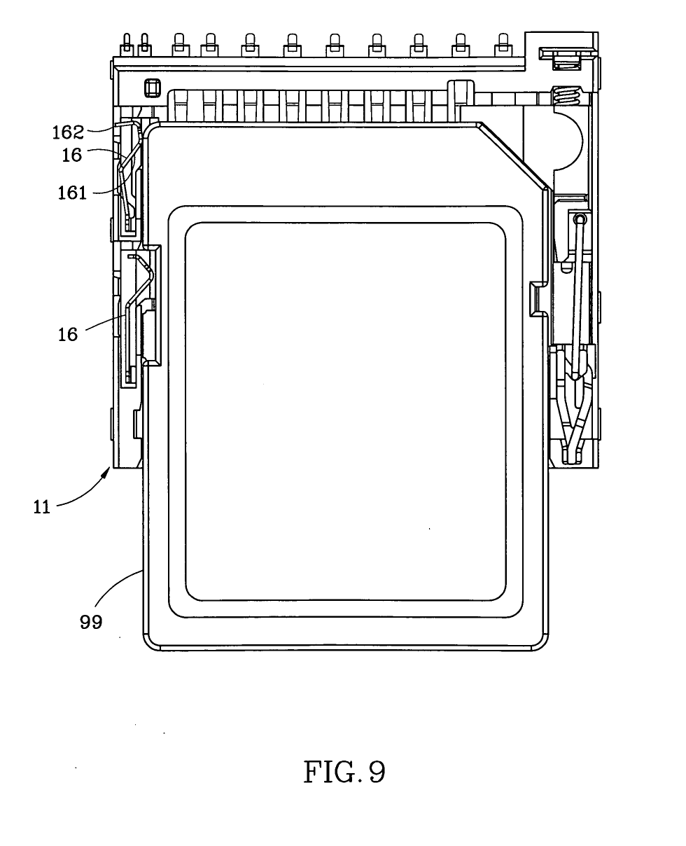

Referring to FIG. 5 in view of FIG. 4 again, when the card 99 is inserted to enter the card space 24, the card 99 can work on the working portion 161 of the working spring strip 16. Next, as shown in FIGS. 6-9, the card 99 continues to be further inserted to force the working spring strip 16 to bend toward the corresponding passive spring strip 26. When the card 99 is inserted to the rearmost end of the card space 24, the contact portion 162 of the working spring strip 16 and pushes against the guiding surface 262 of the corresponding the passive spring strip 26 to force the passive spring strip 26 to deform upward. The rebounding resilience of the passive spring strip 26 keeps itself contacting the working spring strip 16 for stable electric conduction therebetween. Therefore, such electric conduction can attain the detection of entry or write protection of the card 99.

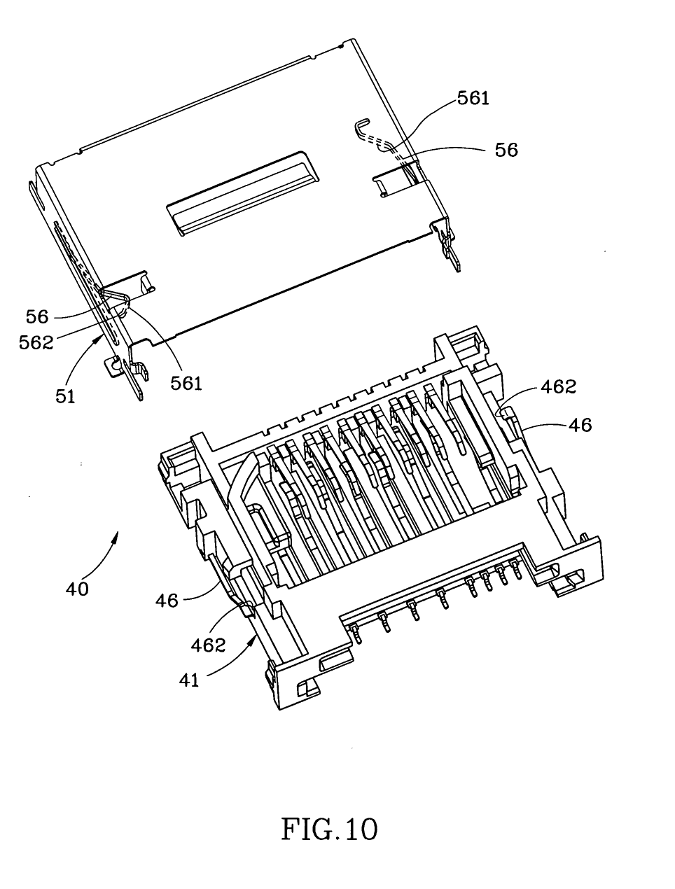

Referring to FIG. 10, a card connector 40 capable of detecting card entry in accordance with a second preferred embodiment of the present invention is similar to that of the first embodiment, having the difference recited below.

The two working spring strips 56 are formed at two sides of the cover 51 respectively. The two passive spring strips 46 are mount to the base 41 by insert molding and located at two sides of the base 41 respectively, corresponding to the two working spring strips 56 respectively.

For the convenience of recitation, the following operation of the second embodiment of the present invention only covers one of the working spring strips 56 and one of the passive spring strips 46 because the operation of the other working and passive spring strips 56 and 46 is almost similar to be skipped.

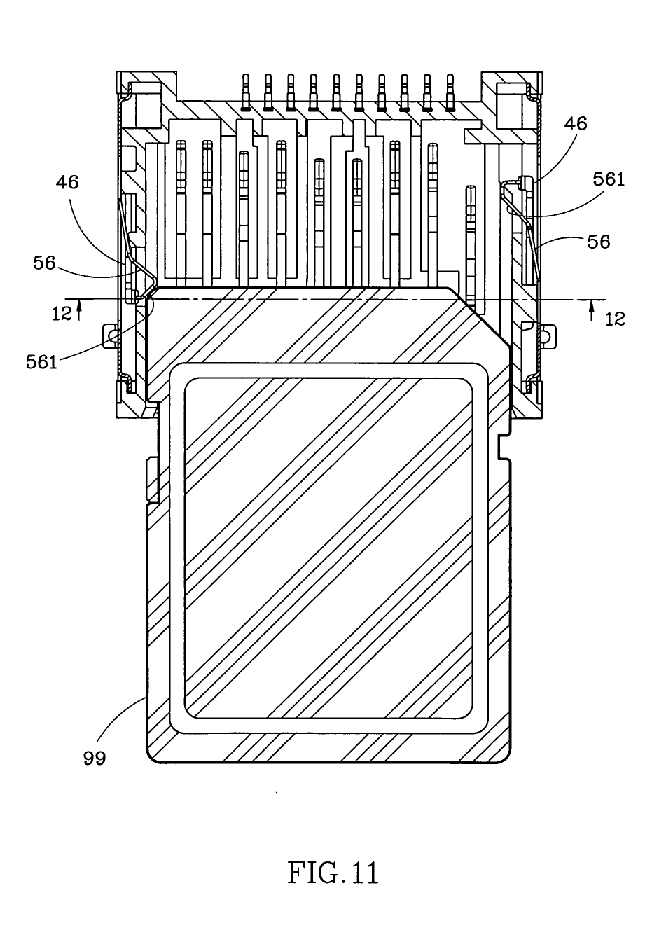

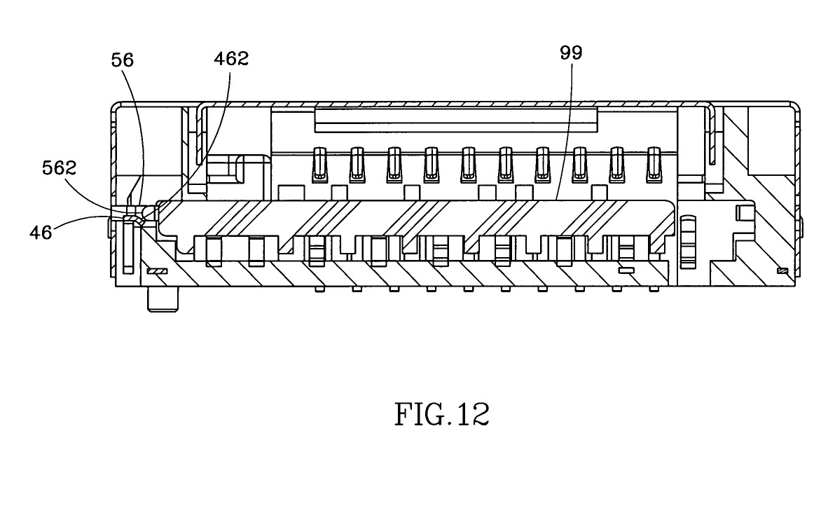

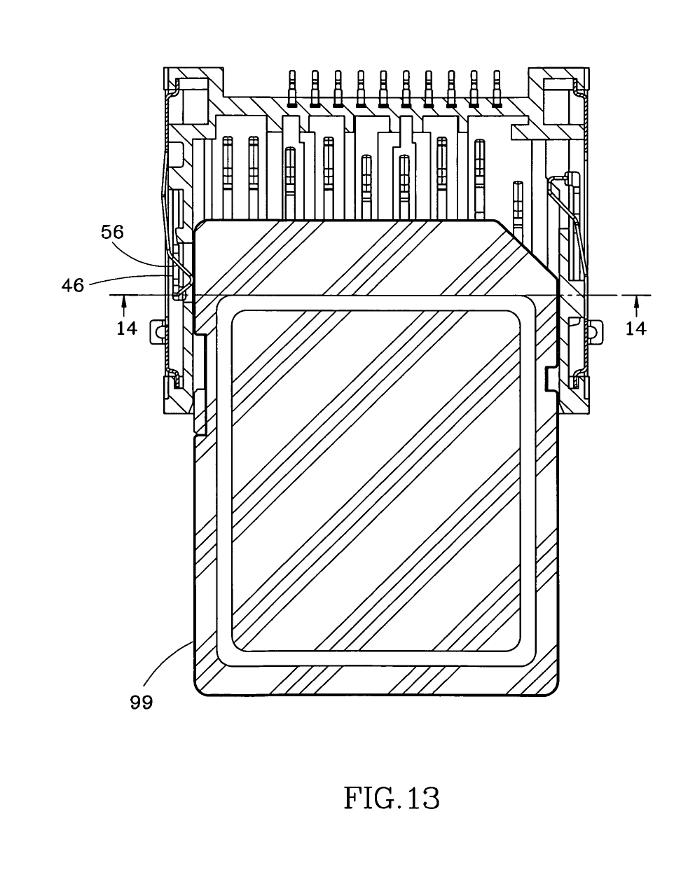

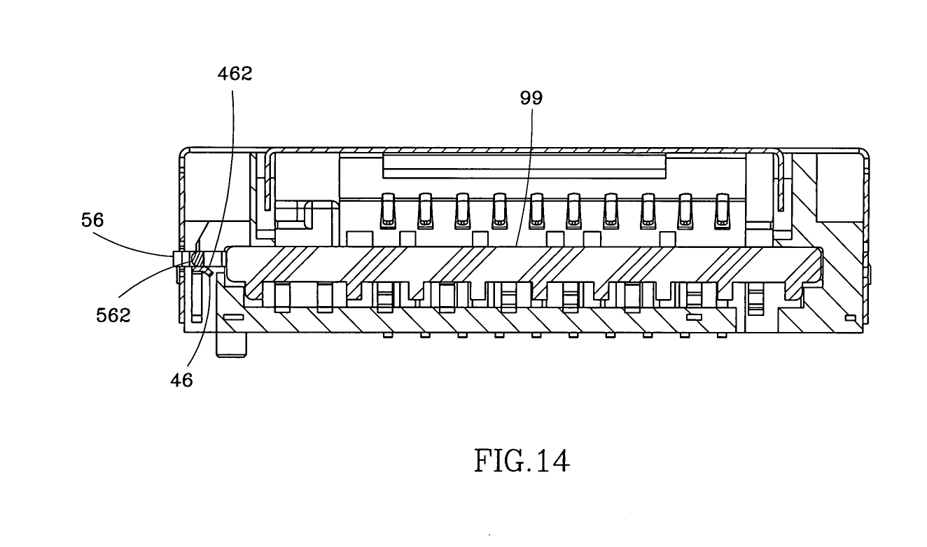

Referring to FIGS. 11-12, when the card 99 is inserted into the card connector 40, a front edge of the card 99 works on the working portion 561 of the working spring strip 56 and meanwhile, the contact portion 562 is spaced from the guiding surface 462 of the corresponding passive spring strip 46 in a predetermined interval without any contact with each other. When the card 99 continues to enter the card space, the working spring strip 56 is forced to bend toward the passive spring strip 46 and meanwhile, the contact portion 562 contacts and works on the guiding surface 462 to force the passive spring strip 46 to deform downward. At the same time, the rebounding resilience of the passive spring strip 46 keeps itself contacting the working spring strip 56 for secure electric conduction therebetween, as shown in FIGS. 13-14. In light of this, the detection of card entry or write protection can be attained by such electric conduction.

In addition, the other components and operational manner of the second embodiment are identical to those of the first embodiment, such that no more description in this regard is necessary.

In conclusion, the present invention includes the following advantages to improve the drawbacks of the prior art. The working and passive spring strips are provided at the base and the cover respectively and while the cover is mounted onto the base, the assembly is accomplished. Therefore, the present invention is structurally simple and convenient in assembly. Besides, when the working spring strip contacts and pushes against the passive spring strip, the contact portion frictionally contacts the guiding surface. Under the circumstances, if the guiding surface is oxidized or smudged, the contact portion can scrape the oxide or the smudge to keep perfect contact to further secure accuracy of the detection.

Although the present invention has been described with respect to specific preferred embodiments thereof, it is no way limited to the details of the illustrated structures but changes and modifications may be made within the scope of the appended claims.

What is claimed is:

1. A card connector capable of detecting entry of a card, comprising:
a base;
a cover made of a metal and mounted onto the base, the base and the cover jointly defining an entrance formed at front sides thereof and a card space formed therebetween; and
a terminal set having a plurality of terminals mounted to the base;
wherein one of the base and the cover includes at least one working spring strip at a side of the card connector and the other includes at least one passive spring strip at the same side of the card connector as the at least one working spring strip; the at least one working spring strip includes a working portion interfering with the card space for bendable contact and electric conduction with the at least one passive spring strip for detection while the card enters the card space to work on the working portion.

2. The card connector as defined in claim 1, wherein the working portion is a bevel extending rearwards toward the card space; when the card is inserted into the card connector to work on the working portion, the working spring strip is forced to bend outwardly toward the at least one passive spring strip.

3. The card connector as defined in claim 2, wherein the at least one working spring strip comprises a contact portion extending toward the at least one passive spring strip; the at least one passive spring strip comprises a guiding surface corresponding to the contact portion; when the at least one working spring strip bends to contact the at least one passive spring strip, the contact portion contacts the guiding surface to force the at least one passive spring strip to deform; the rebounding resilience of the passive spring strip keeps itself contacting the at least one working spring strip.

4. The card connector as defined in claim 3, wherein the at least one passive spring strip is deformed upward or downward.

5. The card connector as defined in claim 3, wherein the guiding surface is inclined to face a distal end of the contact portion.

6. The card connector as defined in claim 1, wherein the at least one working spring strip is located at the cover, and the at least one passive spring strip is located at the base.

7. The card connector as defined in claim 6, wherein the at least one passive spring strip is mount to the base by insert molding.

8. The card connector as defined in claim 1, wherein the at least one passive spring strip is located at the cover, and the at least one working spring strip is located at the base.

9. The card connector as defined in claim 8, wherein the at least one working spring strip is mounted to the base by insert molding.
